(19) United States
(12) Patent Application Publication
(10) Pub. No.: US 2003/0011189 A1
(43) Pub. Date: Jan. 16, 2003

(54) Scrapbook page extender

(76) Inventor: Patti Swoboda, Fremont, NE (US)

Correspondence Address: Robert D. Fish, Suite 1400, 611 Anton Blvd., Costa Mesa, CA, 92626, US

(21) Appl. No.: 10/192,961

(22) Filed: Jul. 9, 2002

Related U.S. Application Data
(60) Provisional application No. 60/304,557, filed on Jul. 10, 2001.

(51) Int. Cl. B42D 1/08

(52) U.S. Cl. 281/22

(57) ABSTRACT

A page extending system comprising a sleeve having an adhesive strip sized and dimensioned to store scrapbook items. The system of may advantageously include a page having two opposing sheets that are sealed on three sides and open on a forth such that the page forms an envelope like structure having a single open side.

### FIELD OF THE INVENTION

The field of the invention is scrapbook page extenders.

### BACKGROUND OF THE INVENTION

Scrapbook pages are generally designed to facilitate the organization and display of scrapbook items. Such items are often pictures or other relatively flat objects, and therefore, traditional scrapbook pages have been designed to accommodate such objects while at the same time allowing for display of the items.

One type of known scrapbook page that facilitates display is a page that has a clear vinyl sleeve within which the scrapbook items are placed. This type of scrapbook page allows a variety of sizes of scrapbook items to be displayed. Display of the items is accomplished primarily because the envelope is clear. A problem with the clear vinyl sleeve, however, is that the inside of the sleeve is generally open, and the items, even if placed carefully into the sleeve, tend to become displaced when the book is lifted or the pages are turned. The sleeve becomes more of a storage area than a display with many items being overlain and entirely obscured by other items. Since items may be displaced and even obscured, it can be difficult to determine the contents of the sleeve.

The problem of displacement of scrapbook items was addressed by U.S. Pat. No. 5,947,522 to Boehm (September 1999), which teaches scrapbook pages that have predefined areas or pockets. The pockets generally keep the items more organized and in place. The '522 patent also provides lettering that identifies a theme, as scrapbooks often are directed toward a specific theme. A problem with theme based scrapbook pages, and in particular those that have pockets, is that adding scrapbook items may be relatively difficult or not possible. For example, a scrapbook item may fit a particular theme, but there may be no open pocket that will accommodate the item. Additionally, scrapbook creators frequently organize their books such that a certain item should be added to a certain page, but there may be no room on that page for the item.

The problem of adding new items to a scrapbook was addressed by U.S. Pat. No. 5,887,900 to Raymond (March 1999). The '900 patent teaches clips, similar to paper clips, that can be added to the scrapbook to hold pictures, cards, and other flat items. A problems with the clips exist in that they will not hold substantially non-flat items. Additionally, the clips are held in place by the scrapbook binder rings, and some scrapbooks don't have binder rings.

Thus, there is a need for improved devices and methods of adding items to a scrapbook and organizing the contents of the scrapbook.

### SUMMARY OF THE INVENTION

Methods and apparatus are provided in which a page extender has two opposing flexible surfaces coupled together on three sides and open on one side. The page extender also has an adhesive strip coupled to at least one of the coupled together sides.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a side view of a prior art scrapbook page extender.

FIG. 2 is a side view of a scrapbook page having a scrapbook page extender.

### DETAILED DESCRIPTION

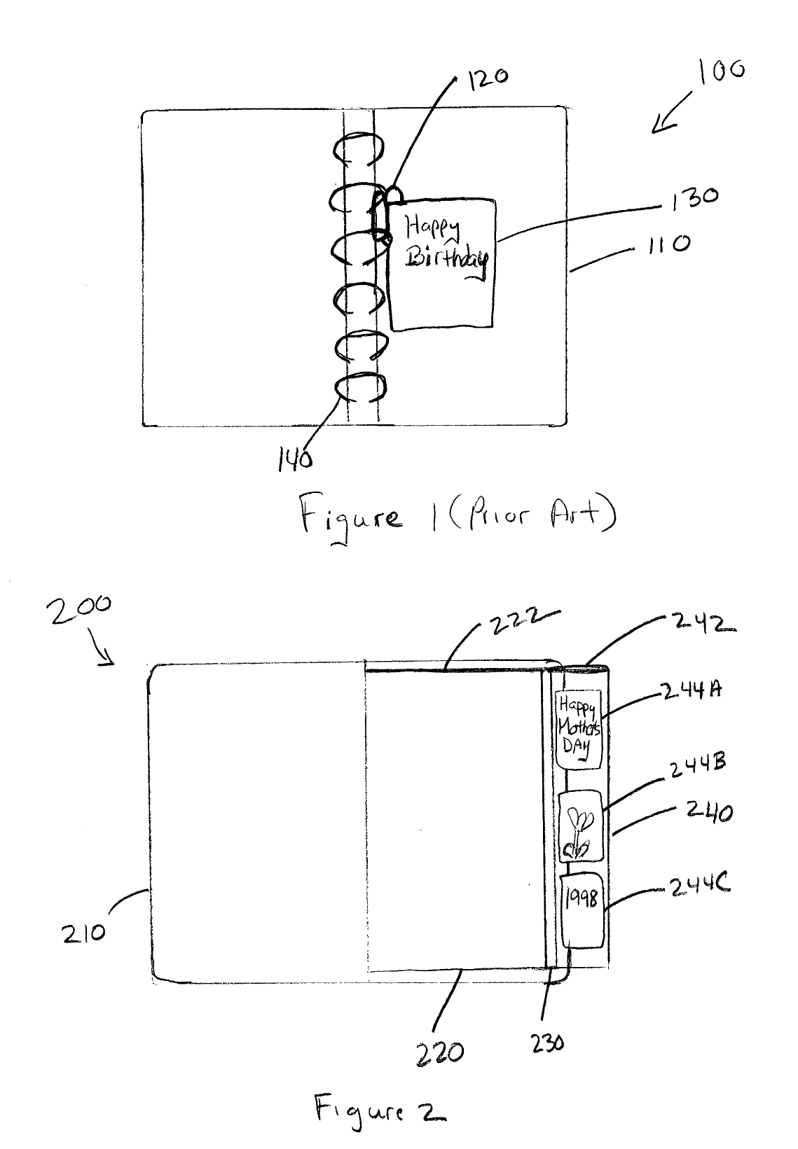

In FIG. 1, a prior art system of extending a scrap book page 100 comprises a scrapbook 110, a scrapbook clip 120, a scrapbook item 130, and binding rings 140.

The scrapbook 110 may have pages (not shown) that have been completely filled with scrapbook items. Yet, the scrapbook owner may desire to add another item to a particular page of the full scrapbook. The scrapbook owner opens the binding rings 140, and puts a scrapbook clip 120 onto two of the rings. The scrapbook clip operates as a large paper clip, and the scrapbook owner is able to add a card 130 or other item that the scrapbook clip is able to hold. In this way, the scrapbook holder is able to store and display an additional scrapbook item. This device, however, is limited. It only functions with relatively flat scrapbook items, and in a scrapbook having binding rings.

In FIG. 2, a page extending system generally comprises a scrapbook 210, a scrapbook page 220, and a sleeve 240. The sleeve 240 has an adhesive strip 230 and is able to store various scrapbook items 244A-244C.

A preferred scrapbook page 220 is comprised of two opposing sheets of clear acrylic that that are sealed on three sides and open on a forth such that the scrapbook page forms an envelope like structure having a single open side. Acrylic and other materials that may come in contact with a scrapbook item are preferably comprised of products that do not promote, and may even retard, deterioration.

Thus, specific embodiments and applications of a scrapbook page extender have been disclosed. It should be apparent, however, to those skilled in the art that many more modifications besides those already described are possible without departing from the inventive concepts herein. The inventive subject matter, therefore, is not to be restricted, except as claimed below. Moreover, in interpreting both the specification, all terms should be interpreted in the broadest possible manner consistent with the context. In particular, the terms “comprises” and “comprising” should be interpreted as referring to elements, components, or steps in a nonexclusive manner, indicating that the referenced elements, components, or steps may be present, or utilized, or combined with other elements, components, or steps that are not expressly referenced.

What is claimed is:

1. A page extending system comprising a sleeve having an adhesive strip sized and dimensioned to store scrapbook items.

2. The system of claim 1 further comprising a page having two opposing sheets that are sealed on three sides and open on a forth such that the page forms an envelope like structure having a single open side.

3. The system of claim 2 wherein the page comprises substantially clear plastic.

4. The system of claim 2 wherein the plastic includes an acrylic.
